(19) United States
(12) Patent Application Publication
(10) Pub. No.: US 2025/0348682 A1
(43) Pub. Date: Nov. 13, 2025

(54) REAL-TIME TELEPROMPTER FOR A VIRTUAL MEETING

(71) Applicant: Google LLC, Mountain View, CA (US)

(72) Inventors: Anton Volkov, Seattle, WA (US); David Alan Sleeper Citron, Kirkland, WA (US); Jennifer Iting Shen, Palo Alto, CA (US); Felix David Mejia Abreu, Orlando, FL (US); Aparna Pappu, Brooklyn, NY (US); Justin Volz, Oakland, CA (US)

(21) Appl. No.: 18/660,516

(22) Filed: May 10, 2024

(51) Int. Cl. G06F 40/35

(52) U.S. Cl. CPC G06F 40/35

(57) ABSTRACT

A method for a real-time teleprompter for a virtual meeting includes causing, during a virtual meeting between one or more participants, a first virtual meeting UI to be displayed to a first participant. The first participant is a current presenter. A first audio stream produced by a client device of the first participant pertains to a presentation of the first participant. The first virtual meeting UI includes a first region displaying teleprompter notes for the presentation of the first participant. The method includes identifying, using an AI model and using the first audio stream as input to the AI model, a first portion of the teleprompter notes that corresponds to a first presentation segment currently covered by the first participant. The method includes causing the first region displaying the teleprompter notes to include a first visual indication that is associated with the first portion of the teleprompter notes.

### TECHNICAL FIELD

Aspects and implementations of the present disclosure relate to virtual meetings and more specifically to a real-time teleprompter for a virtual meeting.

### BACKGROUND

Virtual meetings can take place between multiple participants via a virtual meeting platform. A virtual meeting platform can include tools that allow multiple client devices to be connected over a network and share each other's audio (e.g., voice of a user recorded via a microphone of a client device) and/or video stream (e.g., a video captured by a camera of a client device, or video captured from a screen image of the client device) for efficient communication. To this end, the virtual meeting platform can provide a user interface that includes multiple regions to present the video stream of each participating client device.

### SUMMARY

The below summary is a simplified summary of the disclosure in order to provide a basic understanding of some aspects of the disclosure. This summary is not an extensive overview of the disclosure. It is intended neither to identify key or critical elements of the disclosure, nor delineate any scope of the particular implementations of the disclosure or any scope of the claims. Its sole purpose is to present some concepts of the disclosure in a simplified form as a prelude to the more detailed description that is presented later.

An aspect of the disclosure provides a method for a real-time teleprompter for a virtual meeting. The method includes causing, during a virtual meeting between one or more participants, a first virtual meeting user interface (UI) to be displayed to a first participant of the one or more participants. The first participant is a current presenter. A first audio stream produced by a client device of the first participant pertains to a presentation of the first participant. The first virtual meeting UI includes a first region displaying teleprompter notes for the presentation of the first participant. The method includes identifying, using an artificial intelligence (AI) model and using the first audio stream as input to the AI model, a first portion of the teleprompter notes that corresponds to a first presentation segment currently covered by the first participant. The method includes causing the first region displaying the teleprompter notes to include a first visual indication that is associated with the first portion of the teleprompter notes.

Another aspect of the disclosure provides a system for a real-time teleprompter for a virtual meeting. The system includes a memory and a processing device coupled to the memory. The processing device is configured to perform operations. The operations include causing, during a virtual meeting between one or more participants, a first virtual meeting UI to be displayed to a first participant of the one or more participants. The first participant is a current presenter. A first audio stream produced by a client device of the first participant pertains to a presentation of the first participant. The first virtual meeting UI includes a first region displaying teleprompter notes for the presentation of the first participant. The operations include identifying, using an AI model and using the first audio stream as input to the AI model, a first portion of the teleprompter notes that corresponds to a first presentation segment currently covered by the first participant. The operations include causing the first region displaying the teleprompter notes to include a first visual indication that is associated with the first portion of the teleprompter notes.

Another aspect of the disclosure provides another method for a real-time teleprompter for a virtual meeting. The method includes obtaining first data associated with a first participant of one or more participants of a virtual meeting. The method includes generating, using a first AI model and using the first data as input to the first AI model, teleprompter notes. The method includes causing, during the virtual meeting between the plurality of participants, a first virtual meeting UI to be displayed to the first participant of the one or more participants. The first participant is a current presenter. A first audio stream produced by a client device of the first participant pertains to a presentation of the first participant. The first virtual meeting UI includes a first region displaying the teleprompter notes for the presentation of the first participant. The method includes identifying, using a second AI model and using the first audio stream as input to the second AI model, a first portion of the teleprompter notes that corresponds to a first presentation segment currently covered by the first participant. The method includes causing the first region displaying the teleprompter notes to include a first visual indication that is associated with the first portion of the teleprompter notes.

### BRIEF DESCRIPTION OF THE DRAWINGS

Aspects and implementations of the present disclosure will be understood more fully from the detailed description given below and from the accompanying drawings of various aspects and implementations of the disclosure, which, however, should not be taken to limit the disclosure to the specific aspects or implementations, but are for explanation and understanding only.

FIG. 1 illustrates an example system architecture for a real-time teleprompter for a virtual meeting, in accordance with some implementations of the present disclosure.

FIG. 2 depicts a flow diagram of a method for a real-time teleprompter for a virtual meeting, in accordance with some implementations of the present disclosure.

FIG. 3A illustrates a schematic block diagram for an artificial intelligence (AI) training subsystem of a virtual meeting platform, in accordance with some implementations of the present disclosure.

FIG. 3B illustrates a schematic block diagram for an AI subsystem of a virtual meeting platform, in accordance with some implementations of the present disclosure.

FIG. 4A illustrates an example user interface (UI) for a real-time teleprompter for a virtual meeting, in accordance with some implementations of the present disclosure.

FIG. 4B illustrates an example UI for a real-time teleprompter for a virtual meeting, in accordance with some implementations of the present disclosure.

FIG. 5 illustrates an example UI for a real-time teleprompter for a virtual meeting, in accordance with some implementations of the present disclosure.

FIG. 6 depicts a flow diagram of a method for a real-time teleprompter for a virtual meeting, in accordance with some implementations of the present disclosure.

FIG. 7 is a block diagram illustrating an example computer system, in accordance with some implementations of the present disclosure.

### DETAILED DESCRIPTION

Aspects of the present disclosure relate to a real-time teleprompter for a virtual meeting. A virtual meeting platform can enable video-based conferences between multiple participants via respective client devices that are connected over a network and share each other's audio (e.g., voice of a user recorded via a microphone of a client device) and/or video streams (e.g., a video captured by a camera of a client device) during a virtual meeting. In some instances, a virtual meeting platform can enable a significant number of client devices (e.g., up to one hundred or more client devices) to be connected via the virtual meeting. A participant of a virtual meeting can speak to the other participants of the virtual meeting. Some existing virtual meeting platforms can provide a user interface (UI) to each client device connected to the virtual meeting, where the UI displays visual items corresponding to the video streams shared over the network in a set of regions in the UI.

In a typical virtual meeting, a participant that is presenting often looks into a camera of the participant's client device or looks at a location on the virtual meeting UI near the camera in order to appear to be looking at the other participants of the virtual meeting. This presents several disadvantages. The presenting participant cannot look at speaker notes or other materials without looking away from the camera or the virtual meeting UI, which can look unprofessional or awkward to the other participants. Furthermore, the presenting participant may struggle with pacing while speaking, either rushing through the participant's content or speaking too slowly. The presenting participant may speak without referring to speaker notes or other materials, but the participant may not be adept at speaking without such aids.

Implementations of the present disclosure address the above and other deficiencies by providing a real-time teleprompter to a presenting participant during a virtual meeting. In particular, a virtual meeting UI that is displayed to the presenting participant during the virtual meeting can include a region that includes teleprompter notes for viewing by the presenting participant. The teleprompter notes can be identified using an audio stream produced by a client device of the presenting participant. The audio stream may include speech that the presenting participant speaks.

In some implementations, the audio stream can be provided as input to an artificial intelligence (AI) model to identify a portion of the teleprompter notes that corresponds to a presentation segment currently covered by the presenting participant. For example, the AI model can identify, based on the audio stream, where in the teleprompter notes the presenting participant is currently speaking from. The virtual meeting UI region that displays the teleprompter notes can include a visual indication associated with the identified portion of the teleprompter notes. For example, the region can highlight one or more words of the teleprompter notes displayed in the UI region just beyond the current words that the presenting user is speaking in order to help guide the presenting participant in speaking at an understandable pace.

The AI model can identify, based on the audio stream, whether the presenting participant has stopped speaking from the teleprompter notes (e.g., because the participant is answering another participant's question) or whether the participant has skipped ahead in the teleprompter notes. The virtual meeting UI region can adapt to the deviation from the teleprompter notes in real time by pausing the highlighting of the virtual meeting UI region or by moving the highlighting to a different portion of the teleprompter notes.

Aspects of the present disclosure provide technical advantages over previous solutions. Aspects of the present disclosure provide additional virtual meeting functionality in which a virtual meeting UI guides a presenting participant in speaking from prepared materials at an understandable pace by using an AI model to automatically detect where in teleprompter notes the participant is speaking from, providing speaking suggestions, and automatically adapting to the presenting participant's speech in real time. As a result, quality of virtual meetings and experience of virtual meeting participants are improved.

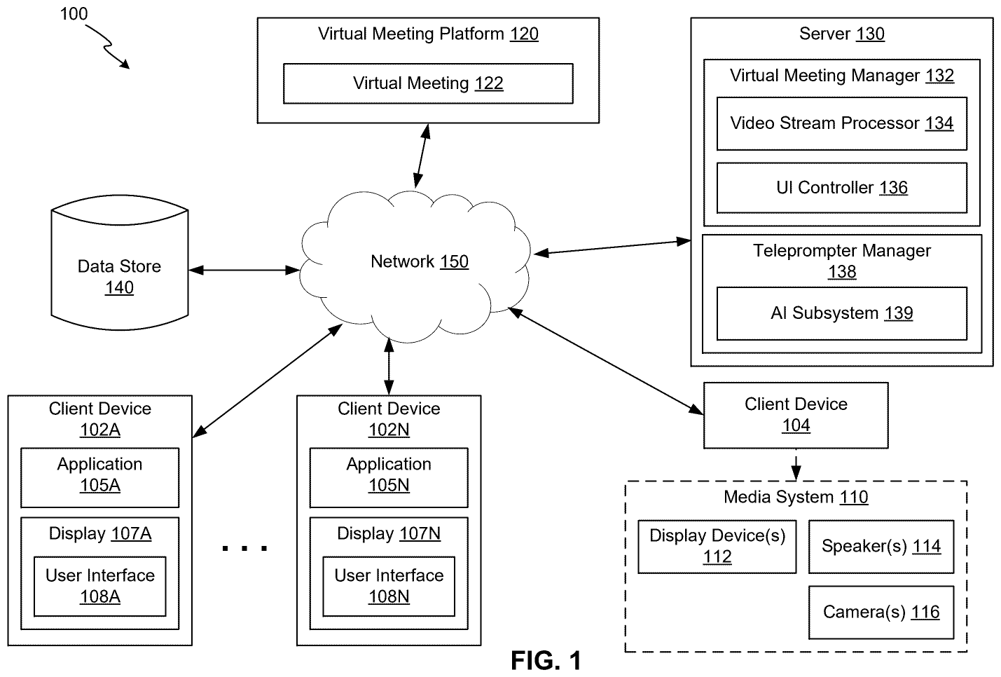

FIG. 1 illustrates an example system architecture 100, in accordance with implementations of the present disclosure. The system architecture 100 includes one or more client devices 102A-N or 104, a virtual meeting platform 120, a server 130, and a data store 140, each connected to a network 150.

In some implementations, the virtual meeting platform 120 enables users of one or more of the client devices 102A-N, 104 to connect with each other in a virtual meeting (e.g., a virtual meeting 122). A virtual meeting 122 refers to a real-time communication session such as a video-based call or video chat, in which participants can connect with multiple additional participants in real-time and be provided with audio and video capabilities. A virtual meeting 122 may include an audio-based call or chat, in which participants connect with multiple additional participants in real-time and are provided with audio capabilities. Real-time communication refers to the ability for users to communicate (e.g., exchange information) instantly without transmission delays and/or with negligible (e.g., milliseconds or microseconds) latency. The virtual meeting platform 120 can allow a user of the virtual meeting platform 120 to join and participate in a virtual meeting 122 with other users of the virtual meeting platform 120 (such users sometimes being referred to, herein, as “virtual meeting participants” or, simply, “participants”). Implementations of the present disclosure can be implemented with any number of participants connecting via the virtual meeting 122 (e.g., up to one hundred or more).

In implementations of the disclosure, a “user” or “participant” can be represented as a single individual. However, other implementations of the disclosure encompass a “user” being an entity controlled by a set of users or an organization and/or an automated source such as a system or a platform. In situations in which the systems discussed here collect personal information about users, or can make use of personal information, the users can be provided with an opportunity to control whether the virtual meeting platform 120 or the virtual meeting manager 132 collects user information (e.g., information about a user's social network, social actions or activities, profession, a user's preferences, or a user's current location), or to control whether or how to receive content from the virtual meeting platform 120 or the virtual meeting manager 132 that can be more relevant to the user. In addition, certain data can be treated in one or more ways before it is stored or used, so that personally identifiable information is removed. For example, a user's identity can be treated so that no personally identifiable information can be determined for the user, or a user's geographic location can be generalized where location information is obtained (such as to a city, ZIP code, or state level), so that a particular location of a user cannot be determined. Thus, the user can have control over how information is collected about the user and used by the virtual meeting platform 120 or the virtual meeting manager 132.

In some implementations, the server 130 includes a virtual meeting manager 132. The virtual meeting manager 132, in one or more implementations, is configured to manage a virtual meeting 122 between multiple users of the virtual meeting platform 120. The virtual meeting manager 132 can provide the UIs 108A-N to each client device 102A-N, 104 to enable users to watch and listen to each other during a virtual meeting 122. The virtual meeting manager 132 can also collect and provide data associated with the virtual meeting 122 to each participant of the virtual meeting 122. In some implementations, the virtual meeting manager 132 provides the UIs 108A-N for presentation by client applications 105A-N. For example, the respective UIs 108A-N can be displayed on the display devices 107A-107N by the client applications 105A-N executing on the operating systems of the client devices 102A-N, 104. In some implementations, the virtual meeting manager 132 determines visual items for presentation in the UIs 108A-N during a virtual meeting. A visual item can refer to a UI element that occupies a particular region in the UI and is dedicated to presenting a video stream from a respective client device. Such a video stream can depict, for example, a user of the respective client device 102A-N, 104 while the user is participating in the virtual meeting 122 (e.g., speaking, listening to other participants, watching other participants, etc., at particular moments during the virtual meeting 122), a physical conference or meeting room (e.g., with one or more participants present), a document or media content (e.g., video content, one or more images, etc.) being presented during the virtual meeting 122, etc.

In some implementations, the virtual meeting manager 132 includes a video stream processor 134 and a UI controller 136. Each of the video stream processor 134 or the UI controller 136 may include a software application (or a subset thereof) that performs certain virtual meeting functionality for the virtual meeting manager 132. The video stream processor 134 may be configured to receive video streams from one or more of the client devices 102A-N, 104. The video stream processor 134 may be configured to determine visual items for presentation in the UI of such client devices 102A-N, 104 (e.g., the UIs 108-108N, discussed below) during the virtual meeting 122. Each visual item can correspond to a video stream from a client device 102A-N, 104 (e.g., the video stream pertaining to one or more participants of the virtual meeting 122). In some implementations, the video stream processor 134 receives audio streams associated with the video streams from the client devices (e.g., from an audiovisual component of the client devices 102A-N, 104). Once the video stream processor 134 has determined visual items for presentation in the UI, the video stream processor 134 can notify the UI controller 136 of the determined visual items. The visual items for presentation can be determined based on current speaker, order of the participants joining the virtual meeting 122, list of participants (e.g., alphabetical), etc.

In some implementations, the UI controller 136 provides the UI for the virtual meeting 122 (e.g., the UI 108A-N). The UI can include multiple regions. A region can display a visual item. A visual item may include a video stream pertaining to one or more participants of the virtual meeting 122. A visual item may include a video stream pertaining to a screen of a client device 102A-N, 104 of the one or more participants (e.g., in response to a participant using a screen sharing feature of the virtual meeting 122 to display the screen of that participant's client device 102A-N, 104). A visual item can include other content displayable on the virtual meeting UI 108A-N. The UI controller 136 can control which visual item is to be displayed by providing a command to one or more client devices 102A-N, 104 that indicates which visual item is to be displayed in which region of the UI 108A-N (along with the received video and audio streams being provided to the client devices 102A-N, 104). For example, in response to being notified of the determined visual items for presentation in the UI 108A-N, the UI controller 136 can transmit a command causing each determined visual item to be displayed in a region of the UI and/or rearranged in the UI.

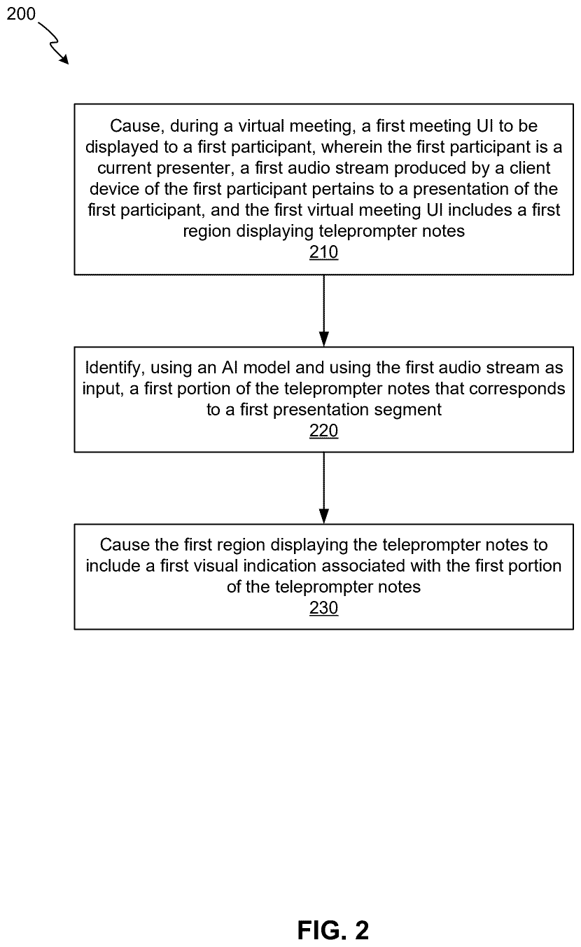

In one or more implementations, the virtual meeting manager 132 includes a teleprompter manager 138. The teleprompter manager 138 may include a software application (or a subset thereof) that performs certain virtual meeting functionality for the virtual meeting manager 132. The teleprompter manager 138 may be configured to provide teleprompter notes to the UI controller 136 for display on the UI 108A-N of a presenting participant. The teleprompter manager 138 may be configured to use an AI model (e.g., of the AI subsystem 139, discussed below) to detect from which portion of the teleprompter notes the presenting participant is speaking. The teleprompter manager 138 can provide data to the UI controller indicating where one or more visual indications should be placed in the UI 108A-N to help guide the presenting participant in speaking from the teleprompter notes. Functionality of the teleprompter manager 138 is discussed further below in relation to FIG. 2.

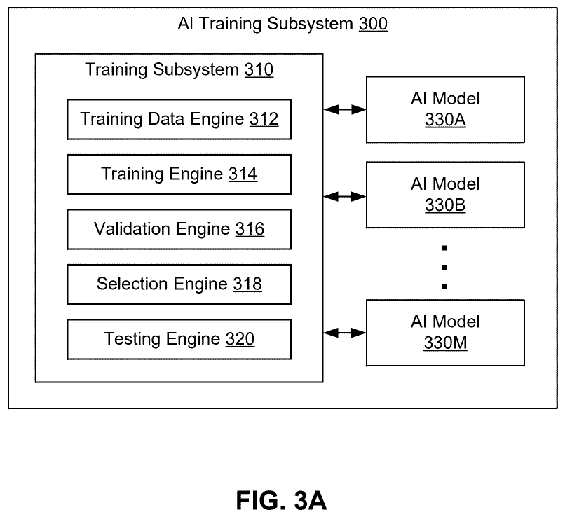

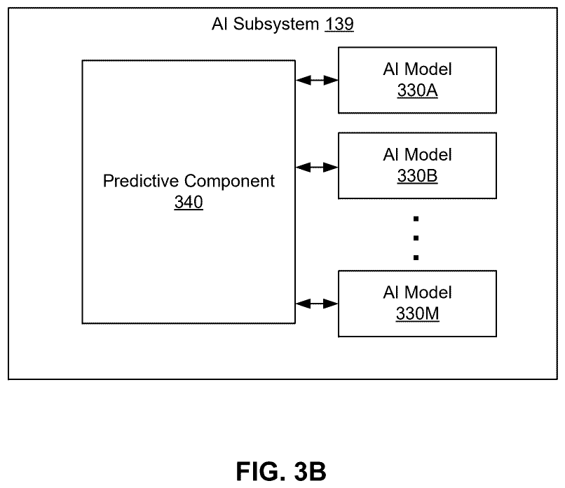

The teleprompter manager 138 may include an AI subsystem 139. The AI subsystem 139 may include one or more AI models configured to identify a portion of the teleprompter notes that corresponds to a presentation segment currently covered by the presenting participant. Functionality of the AI subsystem 139 and one or more models associated with the AI subsystem 139 is discussed further below in relation to FIG. 3A and FIG. 3B.

In some implementations, each of the virtual meeting platform 120 or the server 130 include one or more computing devices (such as a rackmount server, a router computer, a server computer, a personal computer, a mainframe computer, a laptop computer, a tablet computer, a desktop computer, etc.), data stores (e.g., hard disks, memories, databases), networks, software components, and/or hardware components that can be used to enable a user to connect with other users via a virtual meeting 122. The virtual meeting platform 120 can also include a website (e.g., one or more webpages) or application back-end software that can be used to enable a user to connect with other users by way of the virtual meeting 122.

In some implementations, the one or more client devices 102A-N each include one or more computing devices such as personal computers (PCs), laptops, mobile phones, smart phones, tablet computers, netbook computers, network-connected televisions, etc. The one or more client devices 102A-N can also be referred to as “user devices.” Each client device 102A-N can include an audiovisual component that can generate audio and video data to be streamed to the virtual meeting manager 132. The audiovisual component can include a device (e.g., a microphone) to capture an audio signal representing speech of a user and generate audio data (e.g., an audio file or audio stream) based on the captured audio signal. The audiovisual component can include another device (e.g., a speaker) to output audio data to a user associated with a particular client device 102A-N. In some implementations, the audiovisual component includes an image capture device (e.g., a camera) to capture images and generate video data (e.g., a video stream) of the captured data of the captured images.

In some implementations, the system architecture 100 includes a client device 104. The client device 104 can differ from a client device of the one or more client devices 102A-N because the client device 104 may be associated with a physical conference or meeting room. Such client device 104 can include or be coupled to a media system 110 that can include one or more display devices 112, one or more speakers 114 and one or more cameras 116. The display device 112 can be, for example, a smart display or a non-smart display (e.g., a display that is not itself configured to connect to the network 150). Users that are physically present in the room can use the media system 110 rather than their own devices (e.g., one or more of the client devices 102A-N) to participate in the virtual meeting 122, which can include other remote users. For example, the users in the room that participate in the virtual meeting 122 can control the display device 112 to show a slide presentation or watch slide presentations of other participants. Sound and/or camera control can similarly be performed. Similar to client devices 102A-N, the one or more client devices 104 can generate audio and video data to be streamed to the virtual meeting manager 132 (e.g., using one or more microphones, speakers 114 and cameras 116).

As described previously, an audiovisual component of each client device 102A-N, 104 can capture images and generate video data (e.g., a video stream) of the captured data of the captured images. In some implementations, the client devices 102A-N, 104 transmit the generated video stream to virtual meeting manager 132. The audiovisual component of each client device 102A-N, 104 can also capture an audio signal representing speech of a user and generate audio data (e.g., an audio file or audio stream) based on the captured audio signal. In some implementations, the client devices 102A-N, 104 transmit the generated audio data to the virtual meeting manager 132.

In some implementations, each client device 102A-N or 104 includes a respective client application 105A-N, which can be a mobile application, a desktop application, a web browser, etc. The client application 105A-N can present, on a display device 107-107N of a client device 102A-N or a UI (e.g., a UI of the UIs 108A-N), one or more features of the application 105A-N for users to access the virtual meeting platform 120. For example, a user of client device 102A can join and participate in the virtual meeting 122 via a first virtual meeting UI 108A presented on the display device 107A by the application 105A. The user can present a document to participants of the virtual meeting 122 using the first virtual meeting UI 108A. Each of the UIs 108A-N can include multiple regions to present visual items corresponding to video streams of the client devices 102A-N provided to the server 130 for the virtual meeting 122.

In one or more implementations, one or more components of the virtual meeting manager 132 are part of a client device 102A-N, 104. For example, the application 105A of the client device 102A of a participant may include the teleprompter manager 138 to provide the teleprompter functionality discussed. The teleprompter manager 138 can cause the display of the first virtual meeting UI 108A, which can include a virtual meeting UI region that includes teleprompter notes and visual indications that help guide the presenting participant during the virtual meeting 122. In some implementations, the application 105A sends the video stream to the other client devices 102B-N, 104, and receives the video streams from the other client devices 102B-N, 104, and the applications 105A-105N can generate their respective virtual meeting UIs 108A-N or can finalize their respective UIs 108A-N, which may have been partially generated at the server 130.

In some implementations, the data store 140 is a persistent storage that is capable of storing data as well as data structures to tag, organize, and index the data. A data item can include audio data and/or video stream data, in accordance with implementations described herein. The data store 140 can be hosted by one or more storage devices, such as main memory, magnetic or optical storage-based disks, tapes, hard drives, flash memory, and so forth. In some implementations, the data store 140 is a network-attached file server, while in other implementations, the data store 140 is some other type of persistent storage such as an object-oriented database, a relational database, and so forth, that can be hosted by the virtual meeting platform 120 or one or more different machines (e.g., the server 130) coupled to the virtual meeting platform 120 using the network 150. In some implementations, the data store 140 stores portions of audio and video streams received from one or more client devices 102A-N, 104 for the virtual meeting platform 120. Moreover, the data store 140 can store various types of documents, such as a slide presentation, a text document, a spreadsheet, or any suitable electronic document (e.g., an electronic document including text, tables, videos, images, graphs, slides, charts, software programming code, designs, lists, plans, blueprints, maps, etc.). These documents can be shared with users of the client devices 102A-N, 104 and/or concurrently editable by the users.

In some implementations, the network 150 includes a public network (e.g., the Internet), a private network (e.g., a local area network (LAN) or wide area network (WAN)), a wired network (e.g., Ethernet network), a wireless network (e.g., an 802.11 network or a Wi-Fi network), a cellular network (e.g., a Long Term Evolution (LTE) network), routers, hubs, switches, server computers, and/or a combination thereof.

It should be noted that in some implementations, the functions of the virtual meeting platform 120 or the server 130 are provided by a fewer number of machines. For example, in some implementations, the server 130 is integrated into a single machine, while in other implementations, the server 130 is integrated into multiple machines. In addition, in one or more implementations, the server 130 is integrated into the virtual meeting platform 120.

In general, one or more functions described in the several implementations as being performed by the virtual meeting platform 120 or server 130 can also be performed by the client devices 102A-N, 104 in other implementations, if appropriate. In addition, in some implementations, the functionality attributed to a particular component can be performed by different or multiple components operating together. The virtual meeting platform 120 or the server 130 can also be accessed as a service provided to other systems or devices through appropriate application programming interfaces, and thus is not limited to use in websites.

Although implementations of the disclosure are discussed in terms of the virtual meeting platform 120 and users of the virtual meeting platform 120 participating in a virtual meeting 122, implementations can also be generally applied to any type of telephone call, conference call, or other technological communications methods between users. Implementations of the disclosure are not limited to virtual meeting platforms that provide virtual meeting tools to users.

FIG. 2 is a flowchart illustrating one embodiment of a method 200 for a real-time teleprompter for virtual meetings, in accordance with some implementations of the present disclosure. A processing device, having one or more central processing units (CPU(s)), one or more graphics processing units (GPU(s)), and/or memory devices communicatively coupled to the one or more CPU(s) and/or GPU(s) can perform the method 200 and/or one or more of the method's 200 individual functions, routines, subroutines, or operations. In certain implementations, a single processing thread can perform the method 200. Alternatively, two or more processing threads can perform the method 200, each thread executing one or more individual functions, routines, subroutines, or operations of the method. In an illustrative example, the processing threads implementing the method 200 can be synchronized (e.g., using semaphores, critical sections, and/or other thread synchronization mechanisms). Alternatively, the processing threads implementing the method 200 can be executed asynchronously with respect to each other. Various operations of the method 200 can be performed in a different (e.g., reversed) order compared with the order shown in FIG. 2. Some operations of the method 200 can be performed concurrently with other operations. Some operations can be optional. In some implementations, the teleprompter manager 138 performs one or more of the operations of the method 200.

At block 210, processing logic causes, during the virtual meeting 122 between one or more participants, a first virtual meeting UI 108A to be displayed to a first participant of the one or more participants. The first participant can be a current presenter. A first audio stream produced by a client device 102A of the first participant can pertain to a presentation of the first participant. The first virtual meeting UI 108A may include a first region displaying teleprompter notes for the presentation of the first participant.

In some implementations, the first virtual meeting UI 108A is displayed to the first participant on the first participant's client device 102A. The first virtual meeting UI 108A may be different than other virtual meeting UIs 108B-N displayed to other participants of the virtual meeting 122. The first virtual meeting UI 108A may include the first region that displays the teleprompter notes, while other virtual meeting UIs 108B-N may not display the first region with the teleprompter notes.

The first participant being a current presenter may include the first participant being a participant of the virtual meeting 122 that is currently speaking. The first participant being a current presenter may include the first participant being designated, for the virtual meeting 122, as a presenting participant. For example, a host, co-host, panelist, or other participant of the virtual meeting 122 may configure the virtual meeting manager 132 such that the first participant is a current presenter.

In one implementation, the first participant being a current presenter includes the first participant using presentation materials displayed on a virtual meeting UI 108A-N of the virtual meeting 122. The presentation materials may include a slide presentation, a video, an image, or other visual or audio content that can be presented during the virtual meeting 122. In some implementations, a region of the virtual meeting UI 108A-N includes the presentation materials.

In some implementations, the first audio stream includes multiple pieces of audio data produced by the client device 102A of the first participant. The pieces of audio data can be ordered in the order the pieces of audio data were generated. In some implementations, the client device 102A of the first participant provides the first audio stream to the virtual meeting manager 132 over the network 150, and the first audio stream may include a continuous flow of audio data generated by the client device 102A.

In one implementation, the presentation of the first participant includes a portion of the virtual meeting 122 when the first participant speaks, presents materials, or performs other actions during the virtual meeting 122 to be perceived by other participants of the virtual meeting 122. The first audio stream pertaining to the presentation of the first participant can include the first audio stream including audio data that includes the first participant speaking. A video stream may pertain to the presentation of the first participant, and the video stream may include video data that includes images of the first participant. Presentation materials may pertain to the presentation of the first participant, and the presentation materials may include visual or audio materials that the first participant uses during the presentation of the first participant (e.g., a slide presentation, a video, an image, a document, etc.).

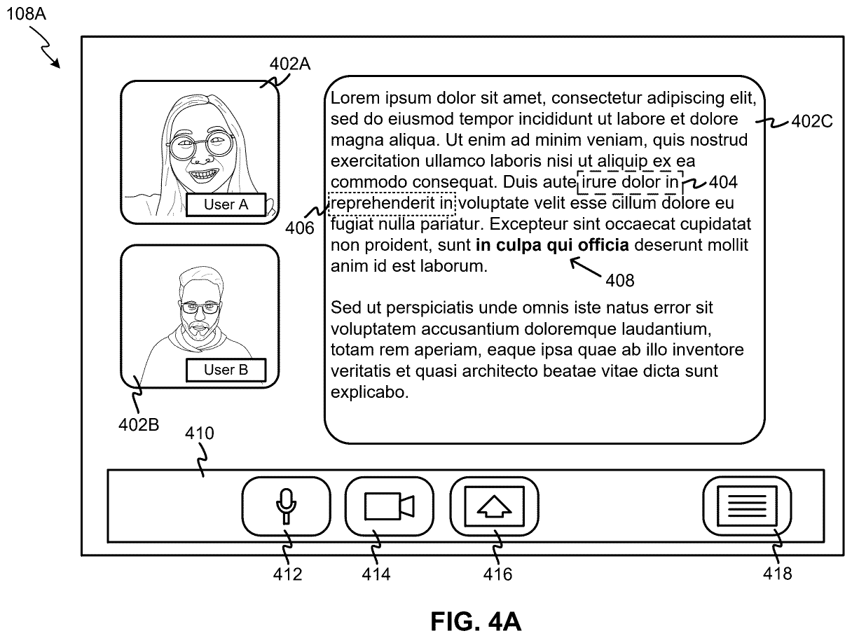

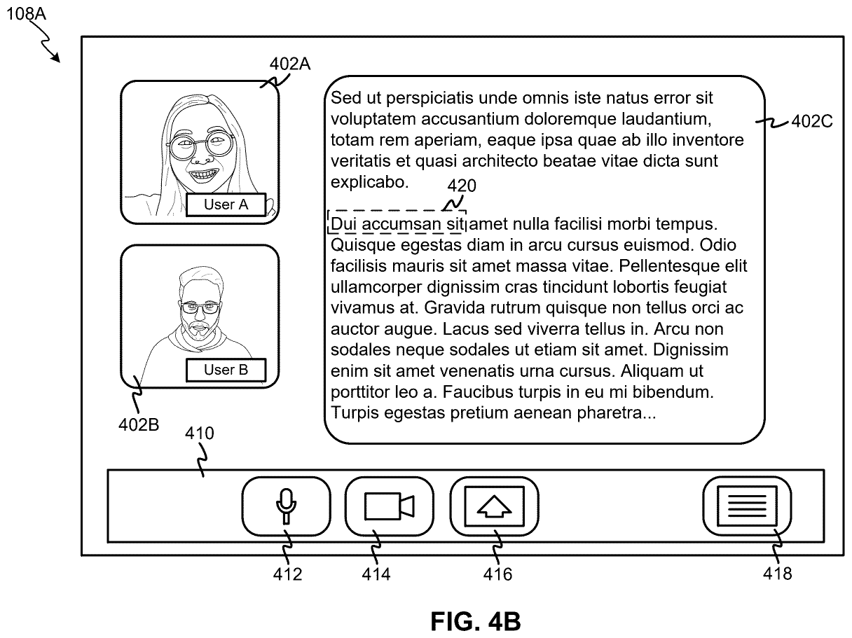

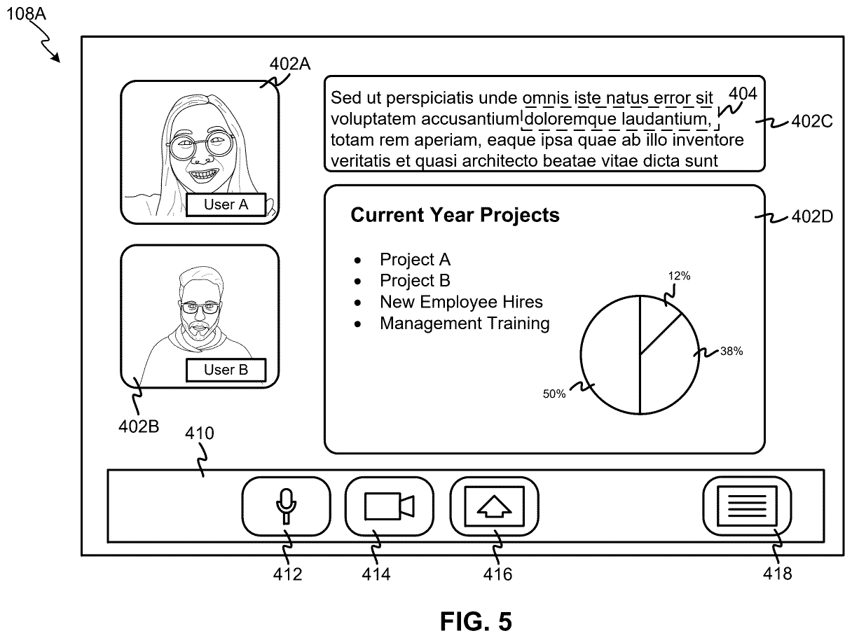

As discussed above, a virtual meeting UI 108A-N includes one or more regions, and each region is configured to display a visual item. In some implementations, a visual item may include the teleprompter notes. In some implementations, the teleprompter manager 138 may obtain the teleprompter notes. The teleprompter notes may be stored in the data store 140, a cloud-AI based content management platform, on the client device 102A of the first participant, or in some other location. The teleprompter manager 138 may provide the teleprompter notes to the UI controller 136, and the UI controller 136 may provide a command to the first virtual meeting UI 108A of the first participant's client device 102 to display the teleprompter notes. The first virtual meeting UI 108A may include a first region that displays a visual item corresponding to the teleprompter notes for the presentation of the first participant. The first virtual meeting UI 108A and the first region are discussed further below in relation to FIG. 4A, FIG. 4B, and FIG. 5.

At block 220, processing logic identifies a first portion of the teleprompter notes that corresponds to a first presentation segment currently covered by the first participant. The processing logic can use an AI model to identify the first portion of the teleprompter notes, and the processing logic can use the first audio stream as input to the AI model.

In one implementation, the AI model includes a speech-to-text AI model. A speech-to-text AI model may include an AI model that has been trained or otherwise configured to receive audio data as input and generate text data that corresponds to the audio data. The text data may include one or more words spoken in the audio data. The AI model is discussed further below in relation to FIG. 3A and FIG. 3B.

In one or more implementations, identifying the first portion of the teleprompter notes that corresponds to the first presentation segment includes the teleprompter manager 138 obtaining a portion of the first audio stream that corresponds to the first presentation segment currently covered by the first participant. In some implementations, the first presentation segment currently covered by the first participant includes one or more words that the first participant is currently speaking. The first presentation segment currently covered by the first participant may include one or more words that the first participant spoke within a threshold amount of time. For example, the threshold amount of time may include 1 second, and the first presentation segment may include one or more words spoken by the first participant less than 1 second ago. The threshold amount of time may include 0.25 seconds, 0.5 seconds, 0.75 seconds, 1 second, 2 seconds, 3 seconds, or some other amount of time. The teleprompter manager 138 can provide the portion of the first audio stream to the AI model as input, and the AI model may generate text data that corresponds to the portion of the first audio stream. The teleprompter manager 138 can compare the text data output from the AI model with the teleprompter notes and identify a portion of the teleprompter notes that corresponds to the text data. The portion of the teleprompter notes that corresponds with the text data may include a portion of the teleprompter notes with one or more words that match the text data. The portion of the teleprompter notes that corresponds with the text data may include a portion of the teleprompter notes with one or more words that are within a threshold string distance of the text data (e.g., using a Levenshtein distance, Damerau-Levenshtein distance, or some other string distance metric).

As an example, the first presentation segment currently covered by the first participant may include the first participant saying, “Looking at slide 5, we can see that sales have increased over the past quarter.” The teleprompter manager 138 may obtain a portion of the first audio stream that includes a portion of audio data that includes the speech of the first participant during the first presentation segment. The teleprompter manager 138 may provide the portion of the first audio stream to the AI model, and the AI model may generate text data that includes the text, “Looking at slide 5, we can see that sales have increased over the past quarter.” The teleprompter manager 138 may identify the portion of the teleprompter notes that corresponds to that text. The teleprompter manager 138 may identify a portion of the teleprompter notes that state, “Looking at slide 5, we see that sales have increased over the past quarter.” The teleprompter manager 138 may calculate that this portion of the teleprompter notes is within a threshold string distance from the text data obtained from the AI model. In response, the teleprompter manager 138 may identify this portion of the teleprompter notes as corresponding to the first presentation segment currently covered by the first participant.

In one implementation, the teleprompter manager 138 compares the text data obtained from the AI model to one or more portions of the teleprompter notes. For example, the teleprompter manager 138 may use a string-searching algorithm or an approximate string-matching algorithm to determine whether the teleprompter notes include a portion that corresponds to the text data. In some implementations, the teleprompter manager 138 or some other component of the system architecture 100 preprocesses the teleprompter notes to generate one or more indices based on the teleprompter notes. The one or more indices may include a substring index or some other data structure. Preprocessing the teleprompter notes may include generating embeddings based on different portions of the teleprompter notes. The teleprompter manager 138 can generate an embedding based on the text data and can compare the text data's embedding to the embeddings of the different portions of the teleprompter notes to identify the portion of the teleprompter notes as corresponding to the first presentation segment currently covered by the first participant.

At block 230, processing logic causes the first region displaying the teleprompter notes to include a first visual indication that is associated with the first portion of the teleprompter notes. The first visual indication may include a visual sign that guides the first participant in speaking effectively from the teleprompter notes.

In one implementation, the first visual indication includes highlighting a portion of the teleprompter notes. For example, a first visual indication associated with the first portion of the teleprompter notes includes highlighting the first portion of the teleprompter notes. This may help the first participant locate the portion of the teleprompter notes where the first participant is currently speaking from. In another example, the first visual indication associated with the first portion of the teleprompter notes includes highlighting a portion of the teleprompter notes located immediately after the first portion. This may help the first participant locate the portion of the teleprompter notes where the first participant is about the speak from.

In some implementations, the first visual indication includes the appearance of a portion of the teleprompter notes in a larger font than other portions of the teleprompter notes. Other visual indications may include bolding a portion of the teleprompter notes, underlining, disposing a symbol near the portion of the teleprompter notes, displaying the portion in a different color than other portions of the teleprompter notes, or other types of visual indications.

In some implementations, the processing logic causes the first region displaying the teleprompter notes to remove the first visual indication and causes the first region to include a second indication associated with a second portion of the teleprompter notes. The second portion of the teleprompter notes can include a portion of the teleprompter notes immediately after the portion of the teleprompter notes that includes the first visual indication. By continuously removing the first visual indication from a portion of the teleprompter notes and including the second visual indication on subsequent portions of the teleprompter notes, the first region can continuously indicate to the first participant from which portion of the teleprompter notes the first participant should read. This can help the first participant read the teleprompter notes at a steady pace. The rate at which the first region displays and removes visual indications from the teleprompter notes can be based on configuration data of the teleprompter manager 138. The first participant may be able to adjust the rate using a UI element of the first virtual meeting UI 108A.

In one implementation, processing logic causes the first region displaying the teleprompter notes to include a second visual indication that is associated with the first portion of the teleprompter notes. The second visual indication may include an indication to emphasize the first portion of the teleprompter notes. The second visual indication can include bolding or underlining the first portion of the teleprompter notes, or some other visual indication. The second visual indication may include an indication to pause after the first portion of the teleprompter notes. The second visual indication can include a symbol placed after the first portion of the teleprompter notes, inserted words and symbols (e.g., “[PAUSE]”), or some other visual indication.

In some implementations, processing logic causes the first region displaying the teleprompter notes to include a second visual indication associated with the first portion of the teleprompter notes. The second visual indication can include text indicating a pronunciation of the first portion of the teleprompter notes. The text indicating a pronunciation of the first portion of the teleprompter notes may include text appearing above the first portion, below the first portion, in a margin near the first portion, or in some other location of the first region.

In one implementation, the first participant may skip over one or more portions of the teleprompter notes. The first participant may do this, for example, because the first participant does not have sufficient time to cover all of the teleprompter notes. The first region of the first virtual meeting UI 108A may adapt to the first participant skipping one or more portions of the teleprompter notes. In some implementations, processing logic identifies a second portion of the teleprompter notes that corresponds to a second presentation segment currently covered by the first participant. The processing logic can use the AI model to identify the second portion of the teleprompter notes, and the processing logic can use the first audio stream as input to the AI model.

In one or more implementations, identifying the second portion of the teleprompter notes that corresponds to the second presentation segment includes the teleprompter manager 138 obtaining a second portion of the first audio stream. The second portion of the first audio stream can correspond to the second presentation segment currently covered by the first participant. The second portion of the first audio stream may include audio data generated after the first audio data that corresponds to the first presentation segment. In some implementations, the second presentation segment includes one or more words that the first participant is currently speaking or that the first participant spoke within a threshold amount of time. The teleprompter manager 138 can provide the second portion of the first audio stream to the AI model as input, and the AI model may generate text data that corresponds to the second portion of the first audio stream. The teleprompter manager 138 can compare the text data output from the AI model with the teleprompter notes and identify a portion of the teleprompter notes that corresponds to the text data. The portion of the teleprompter notes that corresponds with the text data may include a portion of the teleprompter notes with one or more words that match the text data or are within a threshold string distance of the text data. In one implementation, the first portion of the teleprompter notes and the second portion of the teleprompter notes are separated by one or more other portions of the teleprompter notes. Processing logic can cause the first region displaying the teleprompter notes to remove the first visual indication associated with the first portion of the teleprompter notes. Processing logic can cause the first region displaying the teleprompter notes to include a second visual indication associated with the second portion of the teleprompter notes.

As an example, the first portion of the teleprompter notes may include the last three words of a first paragraph of the teleprompter notes. The first participant may decide that there is not sufficient time to read the subsequent second and third paragraphs of the teleprompter notes and may begin reading the first sentence of the fourth paragraph. The teleprompter manager 138 may obtain a portion of the first audio stream that includes the first participant reading the first sentence of the fourth paragraph during the second presentation segment. The teleprompter manager 138 may provide the portion of the first audio stream to the AI model, and the AI model may generate text data that includes the text of the first sentence of the fourth paragraph. The teleprompter manager 138 may identify the second portion of the teleprompter notes that corresponds to that text. The teleprompter manager 138 may calculate that this second portion of the teleprompter notes is within a threshold string distance from the text data obtained from the AI model. In response, the teleprompter manager 138 may identify this second portion of the teleprompter notes as corresponding to the second presentation segment currently covered by the first participant. The teleprompter manager 138 may send data to the UI controller 136 directing the UI controller 136 to cause the first region displaying the teleprompter notes to remove the first visual indication associated with the first portion of the teleprompter notes and to cause the first region displaying the teleprompter notes to include a second visual indication associated with the second portion of the teleprompter notes. The UI controller 136 may send a command to the first virtual meeting UI 108A to update the first region as discussed above.

The teleprompter notes of the first participant may only be displayed on the first virtual meeting UI 108A, and thus, only visible to the first participant. In one implementation, processing logic causes, during the virtual meeting 122 between the one or more participants, a second virtual meeting UI 108B-N to be displayed to a second participant of the one or more participants of the virtual meeting 122. The second participant can be a current audience member of the virtual meeting 122. A current audience member may include a participant that is not the current presenter of the virtual meeting 122. The second virtual meeting UI 108B-N may include a second region displaying a video stream. The video stream may include a video stream produced by the client device 102A of the first participant. The second virtual meeting UI 108B-N may be free of the first region displaying the teleprompter notes. In some implementations, the teleprompter notes of the first participant may be displayed on the virtual meeting UI 108B-N of another participant of the virtual meeting 122. The other participant may include a host, co-host, or other role of the virtual meeting 122.

In some implementations, multiple participants of the virtual meeting 122 may use teleprompter notes. Each virtual meeting UI 108A-N associated with a respective virtual meeting participant may include a region displaying the respective participant's teleprompter notes. The teleprompter manager 138 may perform the functionality discussed above for each participant of the multiple participants regarding the respective participant's teleprompter notes and audio stream.

FIG. 3A illustrates an example AI training subsystem 300 that can be used to train the AI model 330A-M, in accordance with implementations of the present disclosure. As illustrated in FIG. 3, the AI training subsystem 300 can include a training subsystem 310, which may include a training data engine 312, a training engine 314, a validation engine 316, a selection engine 318, or a testing engine 320. The AI training subsystem 300 may be used to train one or more AI models 330A-M.

In one implementation, an AI model 330A-M includes one or more of artificial neural networks (ANNs), decision trees, random forests, support vector machines (SVMs), clustering-based models, Bayesian networks, or other types of machine learning models. ANNs generally include a feature representation component with a classifier or regression layers that map features to a target output space. The ANN can include multiple nodes (“neurons”) arranged in one or more layers, and a neuron may be connected to one or more neurons via one or more edges (“synapses”). The synapses can perpetuate a signal from one neuron to another, and a weight, bias, or other configuration of a neuron or synapse can adjust a value of the signal. Training the ANN may include adjusting the weights or other features of the ANN based on an output produced by the ANN during training.

An ANN may include, for example, a convolutional neural network (CNN), recurrent neural network (RNN), or a deep neural network. A CNN, a specific type of ANN, hosts multiple layers of convolutional filters. Pooling is performed, and non-linearities may be addressed, at lower layers, on top of which a multi-layer perceptron is commonly appended, mapping top layer features extracted by the convolutional layers to decisions (e.g., classification outputs). A deep network may include an ANN with multiple hidden layers or a shallow network with zero or a few (e.g., 1-2) hidden layers. Deep learning is a class of machine learning algorithms that use a cascade of multiple layers of nonlinear processing units for feature extraction and transformation. Each successive layer uses the output from the previous layer as input. An RNN is a type of ANN that includes a memory to enable the ANN to capture temporal dependencies. An RNN is able to learn input-output mappings that depend on both a current input and past inputs. The RNN will address past and future measurements and make predictions based on this continuous measurement information. One type of RNN that can be used is a long short term memory (LSTM) neural network.

ANNs can learn in a supervised (e.g., classification) or unsupervised (e.g., pattern analysis) manner. Some ANNs (e.g., such as deep neural networks) may include a hierarchy of layers, where the different layers learn different levels of representations that correspond to different levels of abstraction. In deep learning, each level learns to transform its input data into a slightly more abstract and composite representation.

In one implementation, an AI model 330A-M includes a generative AI model. A generative AI model can deviate from a machine learning model based on the generative AI model's ability to generate new, original data, rather than making predictions based on existing data patterns. A generative AI model can include a generative adversarial network (GAN), a variational autoencoder (VAE), a large language model (LLM), or a diffusion model. In some instances, a generative AI model can employ a different approach to training or learning the underlying probability distribution of training data, compared to some machine learning models. For instance, a GAN can include a generator network and a discriminator network. The generator network attempts to produce synthetic data samples that are indistinguishable from real data, while the discriminator network seeks to correctly classify between real and fake samples. Through this iterative adversarial process, the generator network can gradually improve its ability to generate increasingly realistic and diverse data.

Generative AI models also have the ability to capture and learn complex, high-dimensional structures of data. One aim of generative AI models is to model underlying data distribution, allowing them to generate new data points that possess the same characteristics as training data. Some machine learning models (e.g., that are not generative AI models) focus on optimizing specific prediction of tasks.

In some implementations, an AI model 330A-M is an AI model that has been trained on a corpus of data. For example, the AI model 330A-M can be an AI model that is first pre-trained on a corpus of data to create a foundational model, and afterwards fine-tuned on more data pertaining to a particular set of tasks to create a more task-specific, or targeted, model. The foundational model can first be pre-trained using a corpus of data that can include data in the public domain, licensed content, and/or proprietary content. Such a pre-training can be used by the AI model 330A-M to learn broad elements including, image or speech recognition, general sentence structure, common phrases, vocabulary, natural language structure, and other elements. In some implementations, this first foundational model is trained using self-supervision, or unsupervised training on such datasets.

In some implementations, the second portion of training, including fine-tuning, includes unsupervised, supervised, reinforced, or any other type of training. In some implementations, this second portion of training includes some elements of supervision, including learning techniques incorporating human or machine-generated feedback, undergoing training according to a set of guidelines, or training on a previously labeled set of data, etc. In a non-limiting example associated with reinforcement learning, the outputs of the AI model 330A-M while training may be ranked by a user, according to a variety of factors, including accuracy, helpfulness, veracity, acceptability, or any other metric useful in the fine-tuning portion of training. In this manner, the AI model 330A-M can learn to favor these and any other factors relevant to users when generating a response. Further details regarding training are provided below.

In some implementations, an AI model 330A-M includes one or more pre-trained models, or fine-tuned models. In a non-limiting example, in some implementations, the goal of the “fine-tuning” can be accomplished with a second, or third, or any number of additional models. For example, the outputs of the pre-trained model may be input into a second AI model that has been trained in a similar manner as the “fine-tuned” portion of training above. In such a way, two more AI models may accomplish work similar to one model that has been pre-trained, and then fine-tuned.

In one implementation, the training subsystem 310 manages the training and testing of an AI model 330A-M. The training data engine 312 can generate training data to train an AI model 330A-M. In an illustrative example, the training data engine 312 can initialize a training set T to null (e.g., { }). The training data engine 312 can add the training data to the training set T and can determine whether training set T is sufficient for training a AI model 330A-M. The training set T can be sufficient for training the AI model 330A-M if the training set T includes a threshold amount of training data, in some implementations. In response to determining that the training set T is not sufficient for training, the training data engine 312 can identify additional data to use as training data. In response to determining that the training set T is sufficient for training, the training data engine 312 can provide the training set T to the training engine 314.

As an example, for the system architecture 100, a first set of training data may include multiple pieces of training data. Each piece may include audio data and a corresponding target output that includes a text version of the audio data. The audio data can include a phoneme, a word, multiple words, a sentence, multiple sentences, or other portions of speech. The training data may be used to train a speech-to-text AI model 330A-N, as discussed herein.

The training engine 314 can train an AI model 330A-M using the training data (e.g., training set T). The AI model 330A-M may refer to the model artifact that is created by the training engine 314 using the training data, where such training data can include training inputs and, in some implementations, corresponding target outputs. The training engine 314 can input the training data into the AI model 330A-M so that the AI model 330A-M can find patterns in the training data and configure itself based on those patterns.

Where the AI model 330A-M uses supervised learning, the training engine 314 can assist the AI model 330A-M in determining whether the AI model 330A-M maps the training input to the target output. Where the AI model 330A-M uses unsupervised learning, the training engine 314 can input the training data into the AI model 330A-M The AI model 330A-M can configure itself based on the input training data, but since the training data may not include a target output, the training engine 314 may not assist the AI model 330A-M in determining whether the AI model 330A-M provided a correct output during the training process.

The validation engine 316 may be capable of validating a trained AI model 330A-M using a corresponding set of features of a validation set from the training data engine 312. The validation engine 316 can determine an accuracy of each of the trained AI models 330A-M based on the corresponding sets of features of the validation set. Where the training data may not include a target output, validating a trained AI model 330A-M may include obtaining an output from the AI model 330A-M and providing the output to another entity for evaluation. The other entity may include another AI model configured to evaluation the output of the AI model 330A-M that is undergoing training. The other entity may include a human. The validation engine 316 can discard a trained AI model 330A-M that has an accuracy that does not meet a threshold accuracy or that otherwise fails evaluation. In some implementations, the selection engine 318 is capable of selecting a trained AI model 330A-M that has an accuracy that meets a threshold accuracy. In some implementations, the selection engine 318 may be capable of selecting the trained AI model 330A-M that has the highest accuracy of multiple trained AI models 330A-M. In some implementations, the selection engine 318 receives input from another AI model or a human and can select a trained AI model 330A-M based on the input.

The testing engine 320 may be capable of testing a trained AI model 330A-M using a corresponding set of features of a testing set from the training data engine 312. For example, a first trained AI model 330A that was trained using a first set of features of the training set may be tested using the first set of features of the testing set. The testing engine 320 can determine a trained AI model 330A-M that has the highest accuracy or other evaluation of all of the trained AI models 330A-M based on the testing sets.

In one implementation, the training engine 314 trains an AI model 330A. The training data engine 312 can generate training data that includes a portion of audio data a corresponding target output that includes a text version of the audio data, and the training engine 314 can cause the AI model 330A to undergo an AI model training process using the training data. The AI model 330A can undergo a validation and testing process using the validation engine 316 and testing engine 320.

In some implementations, the AI training subsystem 300 is part of the server 130, the virtual meeting manager 132, or the teleprompter manager 138. Alternatively, the AI training subsystem 300 may be part of another server, system, sub-system, or it may be an independent system. In some implementations, the AI training subsystem 300 provides the trained one or more AI models 330A-M to the teleprompter manager 138.

As indicated above, in some embodiments, the AI model 330A-M can include an LLM. In some embodiments, the LLM can include generative AI functionality. In such embodiments, the AI model 330A-M can generate new content based on provided input data (e.g., text data). The generative AI model 330A-M can be supported by a prompt subsystem (not shown), which may reside on the system architecture 100. The prompt subsystem may enable a user or a component of the system architecture 100 to provide commands for the generative AI model 330A-M. The prompt subsystem may be configured to perform automated identification of, and facilitate retrieval of, relevant and timely contextual information for efficient and accurate processing of prompts by the AI model 330A-M. Using the network 150 (or another network), the prompt subsystem may be in communication with one or more of a client device 102A-N, 104, the virtual meeting manager 132, or the teleprompter manager 138. Communications between the prompt subsystem and the predictive component 340 may be facilitated by a generative model application programming interface (API), in some embodiments. Communications between the prompt subsystem and one or more client devices 102A-N, 104, the virtual meeting manager 132, or the teleprompter manager 138 may be facilitated by a data management API. In additional or alternative embodiments, the generative model API translates prompts generated by the prompt subsystem into an unstructured natural-language format and, conversely, translates responses received from the AI model 330A-M into any suitable form (e.g., including any structured proprietary format as may be used by the prompt subsystem). Similarly, the data management API can support instructions that may be used to communicate data requests to one or more client devices 102A-N, 104, the virtual meeting manager 132, or the teleprompter manager 138.

As indicated above, a user or a component of the system architecture 100 can interact with the prompt subsystem via a prompt interface. The prompt interface may appear on a UI of a software application (e.g., the application 105A-N) of a client device 102A-N, 104. The prompt interface may include a UI element that can support any suitable types of user inputs (e.g., textual inputs, speech inputs, image inputs, etc.). The UI element may further support any suitable types of outputs (e.g., textual outputs, speech outputs, image outputs, etc.). In some embodiments, the UI element can be a web-based UI element, a mobile application-supported UI element, or any combination thereof. The UI element can include selectable items that enables a user to select from multiple generative AI models 330A-M. The UI element can allow the user to provide consent for the prompt subsystem or the generative AI model 330A-M to access user data or other data stored in the data store 140, process or store new data received from the user, and the like. The UI element can additionally or alternatively allow the user to withhold consent to provide access to user data. In some embodiments, user input entered using the UI element may be communicated to the prompt subsystem by a user API. The user API can be located at the client device 102A-N, 104.

In some embodiments, the prompt subsystem can include a prompt analyzer to support various operations of this disclosure. For example, the prompt analyzer may receive an input (e.g., a prompt submitted by a user of or component of the system architecture 100) and generate one or more intermediate prompts to the generative AI model 330A-M to determine what type of data the generative AI model may need to successfully respond to the input. Upon receiving a response from the generative AI model 330A-M, the prompt analyzer may analyze the response, form a request for relevant contextual data for the data store 140, which may then supply such data. The prompt analyzer may then generate a prompt to the generative AI model 330A-M that includes the original prompt and the contextual data. In some embodiments, the prompt analyzer may, itself, include a lightweight generative AI model that may process the intermediate prompt(s) and determine what type of contextual data may be needed by the generative AI model 330A-M together with the original prompt to ensure a meaningful response from generative AI model 330A-M.

The prompt subsystem may include (or may have access to) instructions stored on one or more tangible, machine-readable storage media of a computing device (e.g., the virtual meeting platform 120, the server 130, or some other computing device) and executable by one or more processing devices of the computing device. In one embodiment, the prompt subsystem may be implemented on a single machine. In some embodiments, the prompt subsystem may be a combination of a client component and a server component. In some embodiments the prompt subsystem may be executed entirely on a client device 102A-N, 104. Alternatively, some portion of the prompt subsystem may be executed on a client device 102A-N, 104 while another portion of the query tool may be executed on a server (e.g., the server 130).

FIG. 3B illustrates an example AI subsystem 139 that the teleprompter manager 138 may use to perform one or more operations, in accordance with implementations of the present disclosure. The AI subsystem 139 may include one or more AI models 330A-M. The one or more AI models 330A-M may include one or more of the AI models 330A-M trained by the AI training subsystem 300.

In some implementations, the AI subsystem 139 includes a predictive component 340. The predictive component 340 can be configured to feed data as input to an AI model 330A-M, e.g., the first audio stream provided by the teleprompter manager 138. The predictive component 340 can be configured to obtain one or more outputs from the one or more AI models 330A-M and provide the one or more outputs to the teleprompter manager 138.

FIG. 4A depicts an example implementation of a first virtual meeting UI 108A, in accordance with implementations of the present disclosure. The first virtual meeting UI 108A may be displayed on the client device 102A of the first participant, which can be a current presenter of the virtual meeting 122. The first virtual meeting UI 108A may include multiple regions that each include a visual element. For example, the region 402A includes a visual element that includes a video stream from a participant of the virtual meeting 122, and the region 402B includes a visual element that includes a video stream of a different participant.

In one implementation, the first virtual meeting UI 108A includes a first region 402C that displays the teleprompter notes. The teleprompter notes may include a first visual indication 404 associated with the first portion of the teleprompter notes. For example, as seen in FIG. 4A, the first visual indication 404 includes a highlighting of the first portion of the teleprompter notes. The teleprompter notes may include a second visual indication 406 associated with the first portion of the teleprompter notes. The second visual indication 406 may include a highlighting of a portion of the teleprompter notes located immediately after the first portion. The first visual indication 404 may highlight a portion of the teleprompter from which the first participant is currently speaking, and the second visual indication 406 may include a portion of the teleprompter from which the first participant should read next. The teleprompter notes may include a third visual indication 408 associated with a third portion of the teleprompter notes, which may include a bolding of the third portion of the teleprompter notes in order to indicate that the first participant should emphasize the third portion. In some implementations, the first region 402C includes a UI element that allows the first participant to scroll the teleprompter notes (e.g., a scrollbar) so the first participant can look ahead on the teleprompter notes.

In one or more implementations, the first virtual meeting UI 108A includes a tool bar 410. The tool bar 410 may include one or more UI elements (buttons, menu items, etc.) that the first participant may interact with to perform virtual meeting operations. For example, as seen in FIG. 4A, the tool bar 410 includes an audio control button 412 used to mute and unmute a participant's audio stream, a camera control button 414 used to mute and unmute a participant's video stream, and a share screen button 416 used to display a screen of a participant's client device's 102A-N, 104 in a region of other participants' virtual meeting UIs 108A-N. In some implementations, the tool bar 410 includes a teleprompter button 418 that, responsive to a participant interacting with the teleprompter button 418, causes the first virtual meeting UI 108A to display or stop displaying the first region 402C with the teleprompter notes.

FIG. 4B depicts another example implementation of the first virtual meeting UI 108A, in accordance with implementations of the present disclosure. The first virtual meeting UI 108A may include one or more components discussed in relation to FIG. 4A, including one or more regions 402A-C or the tool bar 410 that includes various UI elements 412-418. As discussed above, the first participant may skip over one or more portions of the teleprompter notes. For example, as shown in FIG. 4B, the first user has skipped over the last paragraph shown in in the first region 402C in FIG. 4A. The first region 402C of the first virtual meeting UI 108A may adapt to the first participant skipping one or more portions of the teleprompter notes by displaying a fourth visual indication 420 associated with a fourth portion of the teleprompter notes. The teleprompter manager 138 may identify, using the AI model 330A-M and using the first audio stream as input to the AI model 330A-M, the fourth portion of the teleprompter notes that corresponds to a fourth presentation segment currently covered by the first participant, as discussed above. The teleprompter manager 138 may provide data to the UI controller 136 indicating the fourth portion of the teleprompter notes, and the UI controller 136 may provide a command to the first virtual meeting UI 108A to display the fourth visual indication 420 associated with the fourth portion.

FIG. 5 depicts another example implementation of the first virtual meeting UI 108A, in accordance with implementations of the present disclosure. The first virtual meeting UI 108A may include one or more components of the first virtual meeting UI 108A depicted in FIG. 4A or FIG. 4B. For example, the first virtual meeting UI 108A may include one or more regions 402A-C, a first visual indication 404, or the tool bar 410 that includes various UI elements 412-418. In one implementation, the first virtual meeting UI 108A includes a second region 402D. The second region 402D may include a visual item that displays presentation materials. For example, as shown in FIG. 5, the presentation materials of the second region 402D include a slide presentation. In some implementations, the first virtual meeting UI 108A may display or stop displaying the second region 402D including the presentation materials responsive to the first user interacting with the share screen button 416. In some implementations, the second region 402D is displayed by virtual meeting UIs 108B-N of other participants' client devices 102B-N, 104 of the virtual meeting 122.

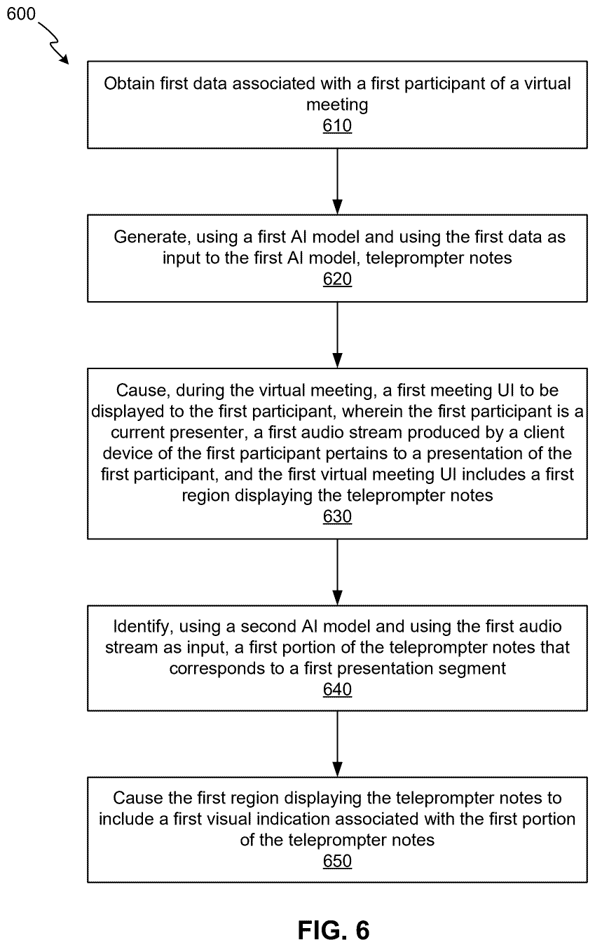

FIG. 6 is a flowchart illustrating one embodiment of a method 600 for a real-time teleprompter for virtual meetings, in accordance with some implementations of the present disclosure. A processing device, having one or more central processing units (CPU(s)), one or more graphics processing units (GPU(s)), and/or memory devices communicatively coupled to the one or more CPU(s) and/or GPU(s) can perform the method 600 and/or one or more of the method's 600 individual functions, routines, subroutines, or operations. In certain implementations, a single processing thread can perform the method 600. Alternatively, two or more processing threads can perform the method 600, each thread executing one or more individual functions, routines, subroutines, or operations of the method. In an illustrative example, the processing threads implementing the method 600 can be synchronized (e.g., using semaphores, critical sections, and/or other thread synchronization mechanisms). Alternatively, the processing threads implementing the method 600 can be executed asynchronously with respect to each other. Various operations of the method 600 can be performed in a different (e.g., reversed) order compared with the order shown in FIG. 6. Some operations of the method 600 can be performed concurrently with other operations. Some operations can be optional. In some implementations, the teleprompter manager 138 performs one or more of the operations of the method 600.

At block 610, processing logic obtains first data associated with a first participant of one or more participants of a virtual meeting 122. The first data may include content from which the teleprompter manager 138 may generate the teleprompter notes. It should be noted that the first participant, as used in relation to the method 600, may not yet have joined the virtual meeting 122. For example, blocks 610 and 620 may occur prior to the start of the virtual meeting 122.

In some implementations, the teleprompter manager 138 obtains the first data. Obtaining the first data may include obtaining the first data over the network 150. Obtaining the first data may include obtaining the first data from the data store 140. Obtaining the first data may include obtaining the first data from the client device 102A associated with the first participant.

In one implementation, obtaining the first data includes obtaining the first data from a cloud-based content management platform. A cloud-based content management platform may provide collaborative tools such as document applications (e.g., word processor, presentation, and spreadsheet applications); a cloud-based document storage service that can store document application documents, image files, video files, audio files, or other file formats; an online calendar; an email service; a messenger, etc. The cloud-based content management platform can allow users to collaborate on a document stored on the platform. The first data may include a document or file accessible to the first participant on the cloud-based content management platform.

In one implementation, the first data includes a slide presentation. The first data may include textual content. The textual content may include a document that includes text data. The textual content may include text data provided by a text input UI element (e.g., a text box) of a software application executing on the first participant's client device 102A.

In one implementation, the first data includes audio data. The audio data may include audio of the first participant speaking. For example, the first participant may speak into a microphone of the client device 102A of the first participant, and a software application of the client device 102A may record the speech as an audio file. The client device 102A may provide the audio file to the teleprompter manager 138. In another example, the first participant may speak into a microphone of the client device 102A of the first participant, and a software application of the client device 102A may generate an audio stream that includes the first participant's speech. The client device 102A may provide the audio stream to the teleprompter manager 138. The teleprompter manager 138 may use a speech-to-text AI model 330A-M to generate a text version of the audio data to be used as the first data.

At block 620, processing logic generates, using a first AI model 330A and using the first data as input to the first AI model 330A, teleprompter notes. In one implementation, the first AI model 330A includes an LLM. Generating the teleprompter notes using the first AI model 330A and using the first data as input to the first AI model 330A may include generating a LLM prompt based on the first data. Generating the LLM prompt may include using the prompt subsystem discussed above in relation to FIG. 3A. The LLM prompt may include the first data. The LLM prompt may include a command for the LLM to generate speaker notes based on the first data. The LLM prompt may include a command for the LLM to summarize the first data. The LLM prompt may include a command for the LLM to expand on the ideas and concepts discussed in the first data (generate additional text with further details on the ideas and concepts). The LLM prompt may include a command for the LLM to modify the first data to include a specific writing style (e.g., professional, formal, semi-formal, casual, scientific, etc.). Generating the teleprompter notes using the first AI model 330A and using the first data as input to the first AI model 330A may include generating, using the LLM prompt as input to the first AI model 330A, the teleprompter notes.

In some implementations, the teleprompter manager 138 may cause the display of the teleprompter notes on a UI of the first participant's client device 102A (e.g., a UI of a software application executing on the client device 102A). The first participant may review the teleprompter notes and decide to modify the teleprompter notes. The first participant may use the client device 102A to generate a second LLM prompt with a command to modify the teleprompter notes. For example, the second LLM prompt may include a command to add content to the teleprompter notes, remove content from the teleprompter notes, modify content in the teleprompter notes, rewrite the teleprompter notes in a different style of writing, or the like. The first participant may use the prompt subsystem to submit the second LLM prompt to the LLM, and the LLM may modify the teleprompter notes accordingly.

At block 630, processing logic causes, during the virtual meeting 122 between the one or more participants, a first virtual meeting UI 108A to be displayed to the first participant of the one or more participants. The first participant may be a current presenter. A first audio stream produced by the client device 102A of the first participant can pertain to a presentation of the first participant. The first virtual meeting UI 108A may include a first region 402C displaying the teleprompter notes for the presentation of the first participant. Block 630 may include functionality similar to the functionality of block 210 of the method 200 of FIG. 2.

At block 640, processing logic identifies, using a second AI model 330B and using the first audio stream as input to the second AI model 330B, a first portion of the teleprompter notes that corresponds to a first presentation segment currently covered by the first participant. Block 640 may include functionality similar to the functionality of block 220 of the method 200.

At block 650, processing logic causes the first region 402C displaying the teleprompter notes to include a first visual indication 404 that is associated with the first portion of the teleprompter notes. Block 650 may include functionality similar to the functionality of block 230 of the method 200.

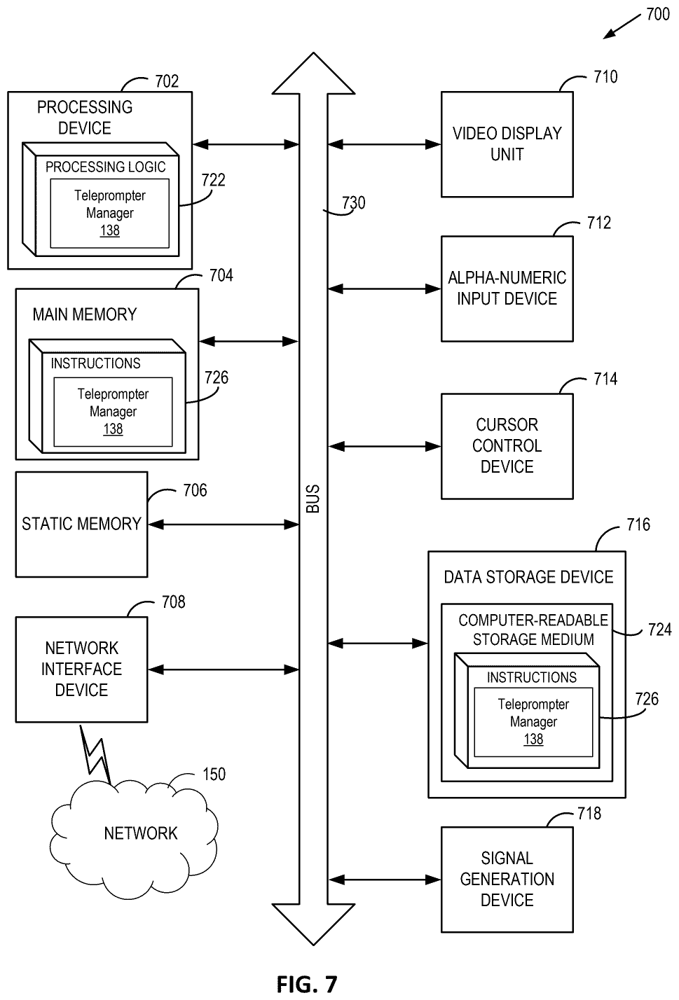

FIG. 7 is a block diagram illustrating an example computer system, in accordance with implementations of the present disclosure. The computer system 700 can include a client device 102A-N, 104, the virtual meeting platform 120, or the server 130 in FIG. 1. The machine can operate in the capacity of a server or an endpoint machine, in an endpoint-server network environment, or as a peer machine in a peer-to-peer (or distributed) network environment. The machine can be a television, a personal computer (PC), a tablet PC, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 700 includes a processing device (processor) 702, a main memory 704 (e.g., read-only memory (ROM), flash memory, dynamic random access memory (DRAM) such as synchronous DRAM (SDRAM), double data rate (DDR SDRAM), or DRAM (RDRAM), etc.), a static memory 706 (e.g., flash memory, static random access memory (SRAM), etc.), and a data storage device 716, which communicate with each other via a bus 730.

The processing device 702 represents one or more general-purpose processing devices such as a microprocessor, central processing unit, or the like. More particularly, the processing device 702 can be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device 702 can also be one or more special-purpose processing devices such as an application specific integrated circuit (ASIC), a field programmable gate array (FPGA), a digital signal processor (DSP), network processor, or the like. The processing device 702 is configured to execute the processing logic 722 for performing the operations discussed herein (e.g., the operations of the teleprompter manager 138).

The computer system 700 can further include a network interface device 708. The computer system 700 also can include a video display unit 710 (e.g., a liquid crystal display (LCD) or a cathode ray tube (CRT)), an input device 712 (e.g., a keyboard, and alphanumeric keyboard, a motion sensing input device, touch screen), a cursor control device 714 (e.g., a mouse), and a signal generation device 718 (e.g., a speaker).

The data storage device 716 can include a non-transitory machine-readable storage medium 724 (sometimes referred to as a “computer-readable storage medium”) on which is stored one or more sets of instructions 726 (e.g., the instructions to carry out one or more operations of the teleprompter manager 138) embodying any one or more of the methodologies or functions described herein. The instructions can also reside, completely or at least partially, within the main memory 704 and/or within the processing device 702 during execution thereof by the computer system 700, the main memory 704 and the processing device 702 also constituting machine-readable storage media. The instructions can further be transmitted or received over the network 150 via the network interface device 708.

In one implementation, the instructions 726 include instructions for determining visual items for presentation in a user interface of a virtual meeting. While the computer-readable storage medium 724 (machine-readable storage medium) is shown in an exemplary implementation to be a single medium, the terms “computer-readable storage medium” and “machine-readable storage medium” should be taken to include a single medium or multiple media (e.g., a centralized or distributed database, and/or associated caches and servers) that store the one or more sets of instructions. The terms “computer-readable storage medium” and “machine-readable storage medium” shall also be taken to include any medium that is capable of storing, encoding or carrying a set of instructions for execution by the machine and that cause the machine to perform any one or more of the methodologies of the present disclosure. The terms “computer-readable storage medium” and “machine-readable storage medium” shall accordingly be taken to include, but not be limited to, solid-state memories, optical media, and magnetic media.

Reference throughout this specification to “one implementation,” or “an implementation,” means that a particular feature, structure, or characteristic described in connection with the implementation is included in at least one implementation. Thus, the appearances of the phrase “in one implementation,” or “in an implementation,” in various places throughout this specification can, but are not necessarily, referring to the same implementation, depending on the circumstances. Furthermore, the particular features, structures, or characteristics can be combined in any suitable manner in one or more implementations.

To the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

As used in this application, the terms “component,” “module,” “system,” or the like are generally intended to refer to a computer-related entity, either hardware (e.g., a circuit), software, a combination of hardware and software, or an entity related to an operational machine with one or more specific functionalities. For example, a component can be, but is not limited to being, a process running on a processor (e.g., digital signal processor), a processor, an object, an executable, a thread of execution, a program, and/or a computer. By way of illustration, both an application running on a controller and the controller can be a component. One or more components can reside within a process and/or thread of execution and a component can be localized on one computer and/or distributed between two or more computers. Further, a “device” can come in the form of specially designed hardware; generalized hardware made specialized by the execution of software thereon that enables hardware to perform specific functions (e.g., generating interest points and/or descriptors); software on a computer readable medium; or a combination thereof.

The aforementioned systems, circuits, modules, and so on have been described with respect to interact between several components and/or blocks. It can be appreciated that such systems, circuits, components, blocks, and so forth can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components can be combined into a single component providing aggregate functionality or divided into several separate sub-components, and any one or more middle layers, such as a management layer, can be provided to communicatively couple to such sub-components in order to provide integrated functionality. Any components described herein can also interact with one or more other components not specifically described herein but known by those of skill in the art.

Moreover, the words “example” or “exemplary” are used herein to mean serving as an example, instance, or illustration. Any aspect or design described herein as “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Finally, implementations described herein include collection of data describing a user and/or activities of a user. In one implementation, such data is only collected upon the user providing consent to the collection of this data. In some implementations, a user is prompted to explicitly allow data collection. Further, the user can opt-in or opt-out of participating in such data collection activities. In one implementation, the collect data is anonymized prior to performing any analysis to obtain any statistical patterns so that the identity of the user cannot be determined from the collected data.

What is claimed is:

1. A method, comprising:
causing, during a virtual meeting between a plurality of participants, a first virtual meeting user interface (UI) to be displayed to a first participant of the plurality of participants, wherein:
the first participant is a current presenter,
a first audio stream produced by a client device of the first participant pertains to a presentation of the first participant, and
the first virtual meeting UI comprises a first region displaying teleprompter notes for the presentation of the first participant;
identifying, using an artificial intelligence (AI) model and using the first audio stream as input to the AI model, a first portion of the teleprompter notes that corresponds to a first presentation segment currently covered by the first participant; and
causing the first region displaying the teleprompter notes to include a first visual indication that is associated with the first portion of the teleprompter notes.

2. The method of claim 1, wherein the AI model comprises a speech-to-text AI model.

3. The method of claim 1, wherein the first visual indication associated with the first portion of the teleprompter notes comprises at least one of:
highlighting the first portion of the teleprompter notes; or
appearance of the first portion of the teleprompter notes in larger font.

4. The method of claim 1, further comprising:
identifying, using the AI model and using the first audio stream as input to the AI model, a second portion of the teleprompter notes that corresponds to a second presentation segment currently covered by the first participant;
causing the first region displaying the teleprompter notes to remove the first visual indication associated with the first portion of the teleprompter notes; and
causing the first region displaying the teleprompter notes to include a second visual indication associated with the second portion of the teleprompter notes.

5. The method of claim 4, wherein the first portion of the teleprompter notes and the second portion of the teleprompter notes are separated by a plurality of other portions of the teleprompter notes.

6. The method of claim 1, further comprising causing the first region displaying the teleprompter notes to include a second visual indication that is associated with the first portion of the teleprompter notes, wherein the second visual indication comprises at least one of:
an indication to emphasize the first portion of the teleprompter notes; or
an indication to pause after the first portion of the teleprompter notes.

7. The method of claim 1, further comprising causing the first region displaying the teleprompter notes to include a second visual indication that is associated with the first portion of the teleprompter notes, wherein the second visual indication comprises text indicating a pronunciation of the first portion of the teleprompter notes.

8. The method of claim 1, further comprising causing, during the virtual meeting between the plurality of participants, a second virtual meeting UI to be displayed to a second participant of the plurality of participants, wherein:
the second participant is a current audience member;
the second virtual meeting UI comprises a second region displaying a video stream produced by the client device of the first participant; and
the second virtual meeting UI is free of the first region displaying the teleprompter notes.

9. A system, comprising:
a memory; and
a processing device, coupled to the memory, configured to perform operations comprising:
causing, during a virtual meeting between a plurality of participants, a first virtual meeting user interface (UI) to be displayed to a first participant of the plurality of participants, wherein:
the first participant is a current presenter,
a first audio stream produced by a client device of the first participant pertains to a presentation of the first participant, and
the first virtual meeting UI comprises a first region displaying teleprompter notes for the presentation of the first participant;
identifying, using an artificial intelligence (AI) model and using the first audio stream as input to the AI model, a first portion of the teleprompter notes that corresponds to a first presentation segment currently covered by the first participant; and
causing the first region displaying the teleprompter notes to include a first visual indication that is associated with the first portion of the teleprompter notes.

10. The system of claim 9, wherein the AI model comprises a speech-to-text AI model.

11. The system of claim 9, wherein the first visual indication associated with the first portion of the teleprompter notes comprises at least one of:
highlighting the first portion of the teleprompter notes; or
appearance of the first portion of the teleprompter notes in larger font.

12. The system of claim 9, further comprising:
identifying, using the AI model and using the first audio stream as input to the AI model, a second portion of the teleprompter notes that corresponds to a second presentation segment currently covered by the first participant;
causing the first region displaying the teleprompter notes to remove the first visual indication associated with the first portion of the teleprompter notes; and
causing the first region displaying the teleprompter notes to include a second visual indication associated with the second portion of the teleprompter notes.

13. The system of claim 12, wherein the first portion of the teleprompter notes and the second portion of the teleprompter notes are separated by a plurality of other portions of the teleprompter notes.

14. The system of claim 9, further comprising causing the first region displaying the teleprompter notes to include a second visual indication that is associated with a second portion of the teleprompter notes, wherein the second visual indication comprises at least one of:
an indication to emphasize the second portion of the teleprompter notes; or
an indication to pause after the second portion of the teleprompter notes.

15. The system of claim 9, further comprising causing the first region displaying the teleprompter notes to include a second visual indication that is associated with a second portion of the teleprompter notes, wherein the second visual indication comprises text indicating a pronunciation of the second portion of the teleprompter notes.

16. The system of claim 9, further comprising causing, during the virtual meeting between the plurality of participants, a second virtual meeting UI to be displayed to a second participant of the plurality of participants, wherein:
the second participant is a current audience member;
the second virtual meeting UI comprises a second region displaying a video stream produced by the client device of the first participant; and
the second virtual meeting UI is free of the first region displaying the teleprompter notes.

17. A method, comprising:
obtaining first data associated with a first participant of a plurality of participants of a virtual meeting;
generating, using a first artificial intelligence (AI) model and using the first data as input to the first AI model, teleprompter notes;
causing, during the virtual meeting between the plurality of participants, a first virtual meeting user interface (UI) to be displayed to the first participant of the plurality of participants, wherein:
the first participant is a current presenter,
a first audio stream produced by a client device of the first participant pertains to a presentation of the first participant, and
the first virtual meeting UI comprises a first region displaying the teleprompter notes for the presentation of the first participant;
identifying, using a second AI model and using the first audio stream as input to the second AI model, a first portion of the teleprompter notes that corresponds to a first presentation segment currently covered by the first participant; and
causing the first region displaying the teleprompter notes to include a first visual indication that is associated with the first portion of the teleprompter notes.

18. The method of claim 17, wherein the first data associated with the first participant of the plurality of participants comprises at least one of a slide presentation or textual content.

19. The method of claim 17, wherein:
the first AI model comprises a large language model (LLM); and
generating, using the first AI model and using the first data as input to the first AI model, teleprompter notes comprises:
generating a LLM prompt based on the first data, and
generating, using the LLM prompt as input to the first AI model, the teleprompter notes.

20. The method of claim 17, wherein obtaining the first data associated with the first participant comprises obtaining the first data from a cloud-based content management platform.
